(19) United States
(12) Patent Application Publication
(10) Pub. No.: US 2024/0420519 A1
(43) Pub. Date: Dec. 19, 2024

(54) INFORMATION PROCESSING DEVICE

(71) Applicants: TOYOTA JIDOSHA KABUSHIKI KAISHA, Toyota-shi (JP); ADVICS CO., LTD., Kariya-shi (JP)

(72) Inventors: Yoshihisa YAMADA, Nagoya-shi (JP); Yosuke KIMURA, Nisshin-shi (JP); Tomoya TANAKA, Kariya-shi (JP); Yasufumi ENAMI, Kariya-shi (JP)

(73) Assignees: TOYOTA JIDOSHA KABUSHIKI KAISHA, Toyota-shi (JP); ADVICS CO., LTD., Kariya-shi (JP)

(21) Appl. No.: 18/738,319

(22) Filed: Jun. 10, 2024

(30) Foreign Application Priority Data
Jun. 16, 2023 (JP) 2023-099312

(51) Int. Cl. G07C 5/04

(52) U.S. Cl. CPC G07C 5/04

(57) ABSTRACT

An information processing device includes one or more processors. The one or more processors are configured to: acquire an actual lateral acceleration being an actual measured value of a lateral acceleration of a vehicle detected by an acceleration sensor mounted on the vehicle over a prescribed period that is predetermined; acquire an estimated lateral acceleration being an estimated value of the lateral acceleration over the prescribed period based on a parameter different from the actual lateral acceleration; calculate an error of the actual lateral acceleration with respect to the estimated lateral acceleration based on the estimated lateral acceleration and the actual lateral acceleration acquired over the prescribed period; determine that there is wheel loosening in the vehicle on condition that the calculated error is equal to or greater than a prescribed value that is predetermined.

### CROSS-REFERENCE TO RELATED APPLICATION

This application claims priority to Japanese Patent Application No. 2023-099312 filed on Jun. 16, 2023, incorporated herein by reference in its entirety.

### BACKGROUND

### 1. Technical Field

The present disclosure relates to information processing devices.

### 2. Description of Related Art

Japanese Unexamined Patent Application Publication (Translation of PCT Application) No. 2018-506470 (JP 2018-506470 A) discloses a method for detecting a wheel being not properly fixed to an axle of a vehicle, that is, detecting wheel loosening. In the wheel loosening detection method of JP 2018-506470 A, a wheel speed signal indicating the rotational speed of the wheel of the vehicle is acquired over a certain period of time. In the wheel loosening detection method, a correction signal is calculated by correcting the acquired wheel speed signal. In the wheel loosening detection method, a low-pass filtered signal is also calculated by low-pass filtering the calculated correction signal. In the wheel loosening detection method, an error of the correction signal with respect to the low-pass filtered signal is then calculated based on the correction signal and the low-pass filtered signal. In the wheel loosening detection method, whether there is wheel loosening is determined based on the calculated error.

### SUMMARY

In the wheel loosening detection method of JP 2018-506470 A, the presence or absence of wheel loosening in a vehicle is determined based on the rotational speed of a wheel. However, JP 2018-506470 A does not pay attention to determining wheel loosening based on parameters other than the rotational speed of the wheel.

An aspect of the present disclosure provides an information processing device. The information processing device includes one or more processors. The one or more processors are configured to: acquire an actual lateral acceleration over a prescribed period that is predetermined, the actual lateral acceleration being an actual measured value of a lateral acceleration of a vehicle detected by an acceleration sensor mounted on the vehicle; acquire an estimated lateral acceleration over the prescribed period based on a parameter different from the actual lateral acceleration, the estimated lateral acceleration being an estimated value of the lateral acceleration; calculate an error of the actual lateral acceleration with respect to the estimated lateral acceleration based on the estimated lateral acceleration and the actual lateral acceleration acquired over the prescribed period; and determine that there is wheel loosening in the vehicle on condition that the calculated error is equal to or greater than a prescribed value that is predetermined.

According to the above configuration, whether there is wheel loosening can be determined based on an error of an actual lateral acceleration with respect to an estimated lateral acceleration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an information processing system;

FIG. 2 is a functional block diagram showing a basic configuration of a motion manager; and

FIG. 3 is a sequence diagram showing collection control, determination control, and distribution control.

### DETAILED DESCRIPTION OF EMBODIMENTS

### Schematic Configuration of Information Processing System

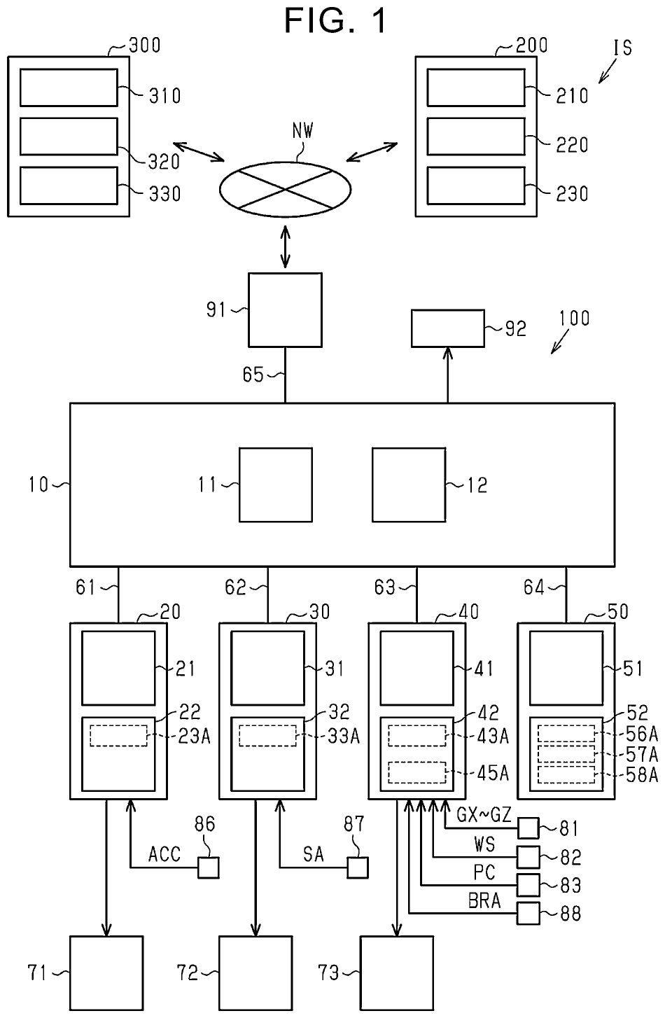

An embodiment of the present disclosure will be described below with reference to FIGS. 1 to 3. First, a schematic configuration of an information processing system IS will be described.

As shown in FIG. 1, the information processing system IS includes a plurality of vehicles 100. An example of the vehicle 100 is an ordinary four-wheeled motor vehicle. Therefore, the vehicle 100 includes a total of four wheels: a right front wheel, a left front wheel, a right rear wheel, and a left rear wheel. Only one vehicle 100 is representatively shown in FIG. 1.

The vehicle 100 includes a powertrain device 71, a steering system 72, and a brake device 73.

The powertrain device 71 includes an engine, a motor generator, and a transmission. The engine can apply a driving force to drive wheels of the vehicle 100 via the transmission. The motor generator can apply a driving force to the drive wheels of the vehicle 100 via the transmission.

An example of the steering system 72 is a rack and pinion electric steering system. The steering system 72 can change the orientation of steered wheels of the vehicle 100 by controlling a rack and a pinion, not shown.

The brake device 73 is a so-called mechanical brake device that mechanically brakes the wheels of the vehicle 100. In the present embodiment, an example of the brake device 73 is a disc brake.

As shown in FIG. 1, the vehicle 100 includes a central ECU 10, a powertrain ECU 20, a steering ECU 30, a brake ECU 40, and an advanced driver assistance ECU 50. The vehicle 100 also includes a first external bus 61, a second external bus 62, a third external bus 63, a fourth external bus 64, and a fifth external bus 65. The term “ECU” is an abbreviation for “electronic control unit.”

The central ECU 10 centrally controls the entire vehicle 100. The central ECU 10 includes an execution device 11 and a storage device 12. An example of the execution device 11 is a central processing unit (CPU). The storage device 12 includes a read-only memory (ROM) that can only be read, a volatile random access memory (RAM) that can be read and written, and a nonvolatile storage that can be read and written. The storage device 12 stores various programs and various types of data in advance. The execution device 11 implements various processes by executing the programs stored in the storage device 12.

The powertrain ECU 20 can communicate with the central ECU 10 via the first external bus 61. The powertrain ECU 20 controls the powertrain device 71 by outputting control signals to the powertrain device 71. The powertrain ECU 20 includes an execution device 21 and a storage device 22. An example of the execution device 21 is a CPU. The storage device 22 includes a ROM, a RAM, and a storage. The storage device 22 stores various programs and various types of data in advance. The storage device 22 also stores a powertrain application 23A as one of the various programs in advance. The powertrain application 23A is application software for controlling the powertrain device 71. The execution device 21 implements a function as a powertrain control unit 23, which will be described later, by executing the powertrain application 23A stored in the storage device 22.

The steering ECU 30 can communicate with the central ECU 10 via the second external bus 62. The steering ECU 30 controls the steering system 72 by outputting control signals to the steering system 72. The steering ECU 30 includes an execution device 31 and a storage device 32. An example of the execution device 31 is a CPU. The storage device 32 includes a ROM, a RAM, and a storage. The storage device 32 stores various programs and various types of data in advance. The storage device 32 also stores a steering application 33A as one of the various programs in advance. The steering application 33A is application software for controlling the steering system 72. The execution device 31 implements a function as a steering control unit 33, which will be described later, by executing the steering application 33A stored in the storage device 32.

The brake ECU 40 can communicate with the central ECU 10 via the third external bus 63. The brake ECU 40 controls the brake device 73 by outputting control signals to the brake device 73. The brake ECU 40 includes an execution device 41 and a storage device 42. An example of the execution device 41 is a CPU. The storage device 42 includes a ROM, a RAM, and a storage. The storage device 42 stores various programs and various types of data in advance. The storage device 42 also stores a brake application 43A as one of the various programs in advance. The brake application 43A is application software for controlling the brake device 73. The storage device 42 further stores a motion manager application 45A as one of the various programs in advance. The motion manager application 45A is application software for arbitrating a plurality of motion requests. The execution device 41 implements a function as a brake control unit 43, which will be described later, by executing the brake application 43A stored in the storage device 42. The execution device 41 also implements a function as a motion manager 45, which will be described later, by executing the motion manager application 45A stored in the storage device 42.

The advanced driver assistance ECU 50 can communicate with the central ECU 10 via the fourth external bus 64. The advanced driver assistance ECU 50 performs various types of driver assistance. The advanced driver assistance ECU 50 includes an execution device 51 and a storage device 52. An example of the execution device 51 is a CPU. The storage device 52 includes a ROM, a RAM, and a storage. The storage device 52 stores various programs and various types of data in advance. The various programs include a first assistance application 56A, a second assistance application 57A, and a third assistance application 58A. An example of the first assistance application 56A is application software for collision damage mitigation braking that automatically applies braking to mitigate collision damage to the vehicle 100, that is, so-called autonomous emergency braking (AEB). An example of the second assistance application 57A is application software for so-called lane keeping assist (LKA) that keeps the vehicle 100 in its lane. An example of the third assistance application 58A is application software for so-called adaptive cruise control (ACC) that allows the vehicle 100 to travel while maintaining a constant following distance from a preceding vehicle traveling ahead of the vehicle 100. In the present embodiment, the first assistance application 56A, the second assistance application 57A, and the third assistance application 58A are each application software that implements driver assistance functions of the vehicle 100. The execution device 51 implements a function as a first assistance unit 56, which will be described later, by executing the first assistance application 25 56A stored in the storage device 52. The execution device 51 also implements a function as a second assistance unit 57, which will be described later, by executing the second assistance application 57A stored in the storage device 52. The execution device 51 also implements a function as a third assistance unit 58, which will be described later, by executing the third assistance application 58A stored in the storage device 52.

As shown in FIG. 1, the vehicle 100 includes an acceleration sensor 81, a wheel speed sensor 82, and a GNSS receiver 83. The vehicle 100 also includes an accelerator operation amount sensor 86, a steering angle sensor 87, and a brake operation amount sensor 88.

The acceleration sensor 81 is a so-called three-axis sensor. That is, the acceleration sensor 81 can detect a longitudinal acceleration GX, a lateral acceleration GY, and a vertical acceleration GZ. The longitudinal acceleration GX is an acceleration along a longitudinal axis of the vehicle 100. The lateral acceleration GY is an acceleration along a lateral axis of the vehicle 100. The vertical acceleration GZ is an acceleration along a vertical axis of the vehicle 100. In the present embodiment, the lateral acceleration GY is an actual measured value of the lateral acceleration of the vehicle 100 detected by the acceleration sensor 81, that is, an actual lateral acceleration.

The wheel speed sensor 82 detects a wheel speed WS that is the rotational speed of a wheel of the vehicle 100. The wheel speed sensor 82 is located near each wheel of the vehicle 100. In the present embodiment, the vehicle 100 includes four wheel speed sensors 82 for the four wheels of the vehicle 100. Only one wheel speed sensor 82 is representatively shown in FIG. 1.

The GNSS receiver 83 detects location coordinates PC, namely coordinates of a point where the vehicle 100 is located, through communication with GNSS satellites, not shown. The term “GNSS” is an abbreviation for “Global Navigation Satellite System.”

The accelerator operation amount sensor 86 detects an accelerator operation amount ACC, namely an operation amount of an accelerator pedal operated by a driver. The steering angle sensor 87 detects a steering angle SA, namely an angular position of a steering wheel operated by the driver. The brake operation amount sensor 88 detects a brake operation amount BRA, namely an operation amount of a brake pedal operated by the driver.

The powertrain ECU 20 acquires a signal indicating the accelerator operation amount ACC from the accelerator operation amount sensor 86. The steering ECU 30 acquires a signal indicating the steering angle SA from the steering angle sensor 87. The brake ECU 40 acquires signals indicating the longitudinal acceleration GX, the lateral acceleration GY, and the vertical acceleration GZ from the acceleration sensor 81. The brake ECU 40 also acquires a signal indicating the location coordinates PC from the GNSS receiver 83. The brake ECU 40 also acquires signals indicating four wheel speeds WS from the four wheel speed sensors 82. The brake ECU 40 acquires a signal indicating the brake operation amount BRA from the brake operation amount sensor 88. The brake ECU 40 can acquire various values, including the accelerator operation amount ACC and the steering angle SA, via the central ECU 10.

The brake ECU 40 calculates a vehicle speed SP, namely the speed of the vehicle 100, at every predetermined control cycle. For example, the brake ECU 40 calculates the vehicle speed SP by multiplying an average value of the four wheel speeds WS by a predetermined coefficient. That is, the brake ECU 40 can acquire the vehicle speed SP.

As shown in FIG. 1, the vehicle 100 includes a DCM 91 and a display 92. The DCM 91 is connected to the central ECU 10 via the fifth external bus 65. The DCM 91 can wirelessly communicate with devices outside the vehicle 100 via a communication network NW. The term “DCM” is an abbreviation for “Data Communication Module.” The display 92 is connected to the central ECU 10. The display 92 can display various types of information based on image data output from the central ECU 10.

As shown in FIG. 1, the information processing system IS includes a server 200. The server 200 includes an execution unit 210, a storage unit 220, and a communication unit 230. The communication unit 230 can communicate with devices outside the server 200 via the communication network NW. The storage unit 220 includes a ROM, a RAM, and a storage. The storage unit 220 stores various programs and various types of data in advance. An example of the execution unit 210 is a CPU. The execution unit 210 implements various processes by executing the various programs stored in the storage unit 220. In the present embodiment, the server 200 is an example of an information processing device.

As shown in FIG. 1, the information processing system IS includes a plurality of personal terminals 300. An example of the personal terminal 300 is a mobile terminal owned by the user of the vehicle 100, a so-called smartphone. Only one personal terminal 300 is representatively shown in FIG. 1. The personal terminal 300 includes an execution unit 310, a storage unit 320, and a communication unit 330. The communication unit 330 can communicate devices outside the personal terminal 300 via the communication network NW. The storage unit 320 includes a ROM, a RAM, and a storage. The storage unit 320 stores various programs and various types of data in advance. An example of the execution unit 310 is a CPU. The execution unit 310 implements various processes by executing the various programs stored in the storage unit 320.

### Basic Configuration Related to Motion Manager

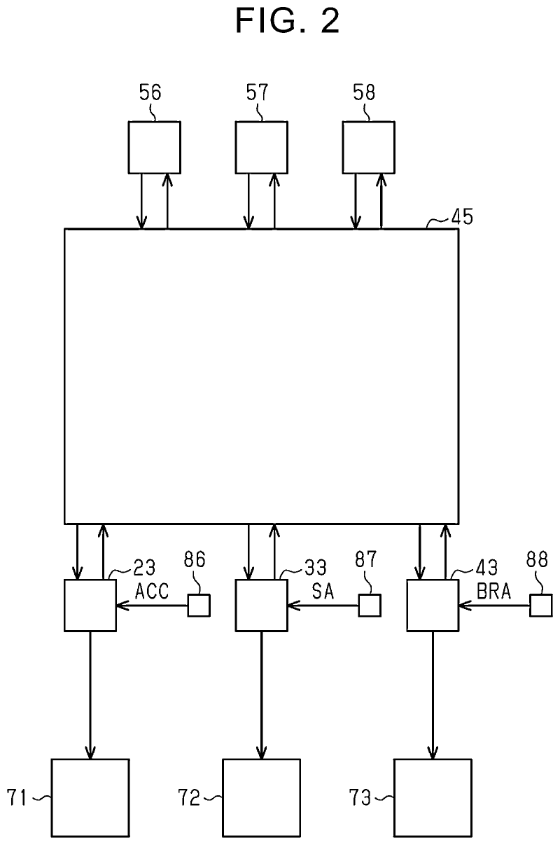

Next, a basic configuration related to the motion manager 45 will be described with reference to FIG. 2. As shown in FIG. 2, the motion manager 45 can communicate with the first assistance unit 56, the second assistance unit 57, and the third assistance unit 58. The motion manager 45 can also communicate with the powertrain control unit 23, the steering control unit 33, and the brake control unit 43.

The first assistance unit 56, the second assistance unit 57, and the third assistance unit 58 output motion requests to the motion manager 45 when executing various types of control. At this time, for example, the first assistance unit 56, the second assistance unit 57, and the third assistance unit 58 continuously output the motion requests from when the various types of control become necessary until such control is no longer necessary. The motion requests include a requested longitudinal acceleration GXR for controlling the acceleration along the longitudinal axis of the vehicle 100.

The motion manager 45 receives requested longitudinal accelerations GXR as the motion requests from the first assistance unit 56, the second assistance unit 57, and the third assistance unit 58. The motion manager 45 arbitrates the received requested longitudinal accelerations GXR. For example, when the motion manager 45 receives requested longitudinal accelerations GXR from a plurality of assistance units, the motion manager 45 selects the earliest received requested longitudinal acceleration GXR as an arbitration result. Alternatively, for example, when the motion manager 45 receives requested longitudinal accelerations GXR from a plurality of assistance units, the motion manager 45 selects the smallest requested longitudinal acceleration GXR as an arbitration result. The motion manager 45 thus arbitrates the motion requests according to a predetermined rule based on the driving condition of the vehicle 100.

The motion manager 45 generates instruction signals for action requests to control various actuators based on the requested longitudinal acceleration GXR selected as the arbitration result. The various actuators include the powertrain device 71, the steering system 72, and the brake device 73. For example, when controlling the powertrain device 71, the motion manager 45 outputs an instruction signal for an action request to the powertrain control unit 23. The powertrain control unit 23 then outputs a control signal to the powertrain device 71 based on the instruction signal for the action request. In this way, an instruction signal output from the motion manager 45 is received by the control unit corresponding to the actuator to be controlled, and the actuator is controlled by the control unit.

Each of the powertrain control unit 23, the steering control unit 33, and the brake control unit 43 can receive an instruction signal for an action request from the driver of the vehicle 100, in addition to an instruction signal for an action request from the motion manager 45. When each of the powertrain control unit 23, the steering control unit 33, and the brake control unit 43 receives an instruction signal for an action request from the driver of the vehicle 100, each of the powertrain control unit 23, the steering control unit 33, and the brake control unit 43 outputs a control signal to its corresponding actuator, based on the instruction signal for the action request from the driver of the vehicle 100. That is, when each control unit receives an instruction signal for an action request from the driver of the vehicle 100, each control unit disables an instruction signal for an action request from the motion manager 45. The powertrain control unit 23 can receive the accelerator operation amount ACC from the accelerator operation amount sensor 86 as an instruction signal for an action request to control the actuator based on the driver's operation. The steering control unit 33 can receive the steering angle SA from the steering angle sensor 87 as an instruction signal for an action request to control the actuator based on the driver's operation. The brake control unit 43 can receive the brake operation amount BRA from the brake operation amount sensor 88 as an instruction signal for an action request to control the actuator based on the driver's operation.

### Collection Control

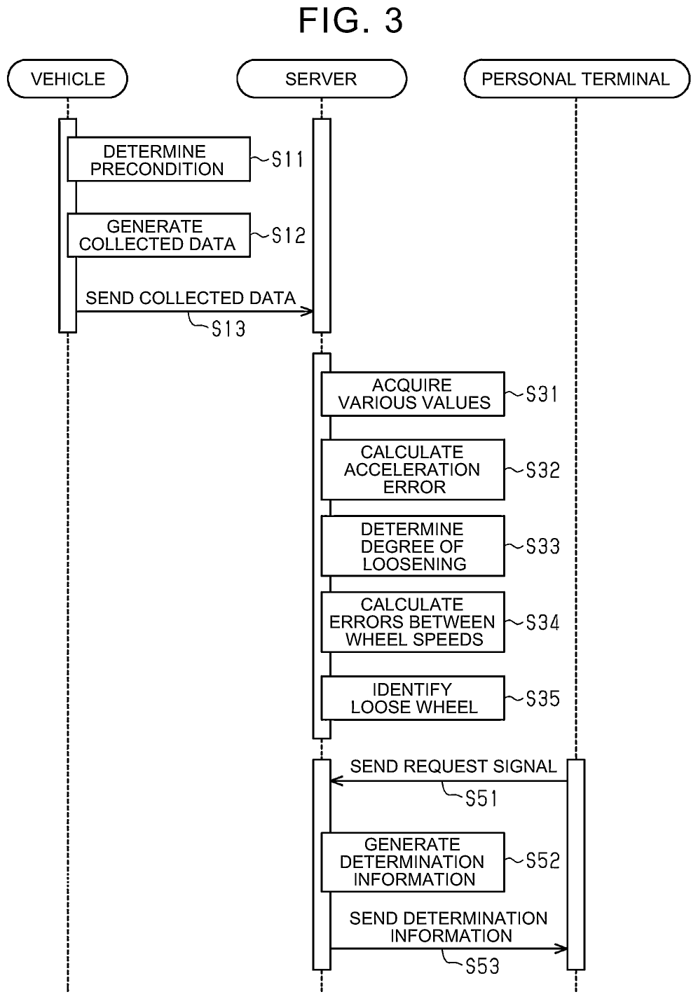

Next, collection control that is executed by the vehicle 100 and the server 200 will be described with reference to FIG. 3. The collection control is control for the server 200 to collect various values from the vehicle 100. The collection control is executed in parallel between a plurality of the vehicles 100 and the single server 200. In the present embodiment, the motion manager 45 of the vehicle 100 executes the collection control at every predetermined control cycle.

As shown in FIG. 3, when the collection control is started, the motion manager 45 of the vehicle 100 performs step S11. In step S11, the motion manager 45 determines whether a predetermined precondition is satisfied. In the present embodiment, the motion manager 45 determines that the precondition is satisfied when all of the following requirements (1) to (4) are met.
Requirement (1): Various sensors are normal and various ECUs are normal.
Requirement (2): The amount of change in vehicle speed SP per unit time is equal to or less than a predetermined reference amount of change.
Requirement (3): The amount of change in steering angle SA per unit time is equal to or less than a predetermined specific amount of change.
Requirement (4): The vehicle speed SP is within a predetermined reference speed range.

The reference speed range is determined in advance through experiments, simulations, etc. as a range of the vehicle speed SP for ensuring accuracy of determination in determination control that will be described later. An example of the reference speed range is about ten-odd kilometers per hour to about several tens of kilometers per hour.

When the motion manager 45 determines in step S11 that the precondition is not satisfied, the motion manager 45 ends the current collection control. On the other hand, when the motion manager 45 determines in step S11 that the precondition is satisfied, the process proceeds to step S12.

In step S12, the motion manager 45 generates collected data DC. In the present embodiment, the motion manager 45 generates data including the vehicle speed SP, the steering angle SA, the lateral acceleration GY, and the four wheel speeds WS as the collected data DC. After step S12, the process proceeds to step S13.

In step S13, the motion manager 45 of the vehicle 100 sends the collected data DC to the server 200. As a result, the execution unit 210 of the server 200 acquires the collected data DC. At this time, the execution unit 210 of the server 200 stores the acquired collected data DC in the storage unit 220. As the collection control is repeatedly executed, the execution unit 210 of the server 200 can acquire the collected data DC sent from each vehicle 100 in chronological order. After step S13, the execution unit 210 of the server 200 ends the current collection control.

### Determination Control

Next, determination control that is executed by the server 200 will be described with reference to FIG. 3. The determination control is control for determining whether there is wheel loosening in the vehicle 100. In the present embodiment, the execution unit 210 of the server 200 executes the determination control on the condition that the execution unit 210 has successfully continuously acquired the collected data DC from the same vehicle 100 over a prescribed period that is predetermined. An example of the prescribed period is about several seconds to about ten-odd seconds.

As shown in FIG. 3, when the determination control is started, the execution unit 210 of the server 200 performs step S31. In step S31, the execution unit 210 acquires the lateral acceleration GY for the prescribed period from the collected data DC for the prescribed period. In the present embodiment, the lateral acceleration GY takes a positive value when the vehicle 100 is turning left. On the other hand, the lateral acceleration GY takes a negative value when the vehicle 100 is turning right.

The execution unit 210 also acquires the steering angle SA and vehicle speed SP for the prescribed period from the collected data DC for the prescribed period. The execution unit 210 then calculates an estimated lateral acceleration GYE, namely an estimated value of the lateral acceleration of the vehicle 100, based on the steering angle SA and the vehicle speed SP. For example, the estimated lateral acceleration GYE has a positive value when the steering angle SA is such an angle that the vehicle 100 is turning left. On the other hand, the estimated lateral acceleration GYE has a negative value when the steering angle SA is such an angle that the vehicle 100 is turning right. The execution unit 210 calculates the estimated lateral acceleration GYE over the prescribed period. In the present embodiment, the estimated lateral acceleration GYE is an estimated value of the lateral acceleration of the vehicle 100 acquired based on the steering angle SA and vehicle speed SP that are parameters different from the lateral acceleration GY.

The execution unit 210 also acquires the four wheel speeds WS for the prescribed period from the collected data DC for the prescribed period. In other words, the execution unit 210 acquires the wheel speeds WS of the right front wheel, left front wheel, right rear wheel, and left rear wheel of the vehicle 100 over the prescribed period. After step S31, the process proceeds to step S32.

In step S32, the execution unit 210 calculates an acceleration error DG, namely a mean squared error of the lateral acceleration GY with respect to the estimated lateral acceleration GYE, based on the estimated lateral acceleration GYE and lateral acceleration GY acquired over the prescribed period. As described above, the collected data DC is acquired at every predetermined control cycle. Therefore, there are a plurality of estimated lateral accelerations GYE and a plurality of lateral accelerations GY for the prescribed period as the values acquired at every predetermined control cycle. In the following description, it is assumed that there are N pieces of data for each of the estimated lateral acceleration GYE and lateral acceleration GY for the prescribed period. Note that “N” is an integer of 2 or more. The N pieces of data consist of data at a first time point, data at a second time point, . . . and data at an Nth time point in chronological order with the data at the first time point being the oldest. In step S32, the execution unit 210 calculates the square of the difference between the estimated lateral acceleration GYE at the first time point and the lateral acceleration GY at the first time point. The execution unit 210 also calculates the square of the difference between the estimated lateral acceleration GYE at the second time point and the lateral acceleration GY at the second time point. Similarly, the execution unit 210 calculates the square of the difference between the estimated lateral acceleration GYE and the lateral acceleration GY for each of the third to Nth time points. The execution unit 210 then calculates, as the acceleration error DG, an average value of the N values calculated as described above. In the present embodiment, the acceleration error DG is an example of an error of the lateral acceleration GY with respect to the estimated lateral acceleration GYE. After step S32, the process proceeds to step S33.

In step S33, the execution unit 210 determines the degree of wheel loosening in the vehicle 100 based on the acceleration error DG. Specifically, the execution unit 210 determines the degree of wheel loosening as follows. The execution unit 210 uses a predetermined first prescribed value A1, a predetermined second prescribed value A2, and a predetermined third prescribed value A3. The second prescribed value A2 is greater than the first prescribed value Al. The third prescribed value A3 is greater than the second prescribed value A2. The first prescribed value A1, the second prescribed value A2, and the third prescribed value A3 are determined in advance through experiments, simulations, etc. as threshold values for determining the degree of wheel loosening.

When the acceleration error DG is less than the first prescribed value A1, the execution unit 210 determines that the vehicle 100 is in a first state in which there is no wheel loosening. When the acceleration error DG is equal to or greater than the first prescribed value A1 and less than the second prescribed value A2, the execution unit 210 determines that the vehicle 100 is in a second state in which there is wheel loosening. When the acceleration error DG is equal to or greater than the second prescribed value A2 and less than the third prescribed value A3, the execution unit 210 determines that the vehicle 100 is in a third state in which there is wheel loosening. The third state is a state in which the degree of wheel loosening is greater than in the second state. When the acceleration error DG is equal to or greater than the third prescribed value A3, the execution unit 210 determines that the vehicle 100 is in a fourth state in which there is wheel loosening. The fourth state is a state in which the degree of wheel loosening is greater than in the third state. As described above, the execution unit 210 determines that there is no wheel loosening when the acceleration error DG is less than the first prescribed value A1. The execution unit 210 determines that there is wheel loosening when the acceleration error DG is equal to or greater than the first prescribed value A1.

Every time the execution unit 210 determines the degree of wheel loosening, the execution unit 210 stores the determined degree of wheel loosening in the storage unit 220. Moreover, when a newly determined degree of wheel loosening is greater than the past degrees of wheel loosening stored in the storage unit 220, the execution unit 210 stores in the storage unit 220 the newly determined degree of wheel loosening in association with information on the date and time this determination was made. For example, it is herein assumed that the maximum value of the past degrees of wheel loosening stored in the storage unit 220 is the second state. In this case, when the execution unit 210 determines in step S33 that the degree of wheel loosening is the third state or the fourth state, the execution unit 210 stores in the storage unit 220 this newly determined degree of wheel loosening in association with information on the date and time this determination was made. After step S33, the process proceeds to step S34.

In step S34, the execution unit 210 calculates a first wheel speed error DW1, namely a mean squared error between the wheel speed WS of the right front wheel and the wheel speed WS of the left front wheel, based on the wheel speed WS of the right front wheel and wheel speed WS of the left front wheel of the vehicle 100 acquired over the prescribed period. Specifically, the execution unit 210 calculates the square of the difference between the wheel speed WS of the right front wheel at the first time point and the wheel speed WS of the left front wheel at the first time point. The execution unit 210 also calculates the square of the difference between the wheel speed WS of the right front wheel at the second time point and the wheel speed WS of the left front wheel at the second time point. Similarly, the execution unit 210 calculates the square of the difference between the wheel speed WS of the right front wheel and the wheel speed WS of the left front wheel for each of the third to Nth time points. The execution unit 210 then calculates, as the first wheel speed error DW1, an average value of the N values calculated as described above. In the present embodiment, the first wheel speed error DW1 is an example of an error between the wheel speed WS of the right front wheel and the wheel speed WS of the left front wheel.

The execution unit 210 similarly calculates a second wheel speed error DW2, namely a mean squared error between the wheel speed WS of the right rear wheel and the wheel speed WS of the left rear wheel, based on the wheel speed WS of the right rear wheel and wheel speed WS of the left rear wheel of the vehicle 100 acquired over the prescribed period. In the present embodiment, the second wheel speed error DW2 is an example of an error between the wheel speed WS of the right rear wheel and the wheel speed WS of the left rear wheel. The execution unit 210 also calculates a third wheel speed error DW3, namely a mean squared error between the wheel speed WS of the right front wheel and the wheel speed WS of the right rear wheel, based on the wheel speed WS of the right front wheel and wheel speed WS of the right rear wheel of the vehicle 100 acquired over the prescribed period. In the present embodiment, the third wheel speed error DW3 is an example of an error between the wheel speed WS of the right front wheel and the wheel speed WS of the right rear wheel. The execution unit 210 also calculates a fourth wheel speed error DW4, namely a mean squared error between the wheel speed WS of the left front wheel and the wheel speed WS of the left rear wheel, based on the wheel speed WS of the left front wheel and wheel speed WS of the left rear wheel of the vehicle 100 acquired over the prescribed period. In the present embodiment, the fourth wheel speed error DW4 is an example of an error between the wheel speed WS of the left front wheel and the wheel speed WS of the left rear wheel. After step S34, the process proceeds to step S35.

In step S35, the execution unit 210 identify the wheel of the vehicle 100 that is most likely to be loose, based on the first wheel speed error DW1, the second wheel speed error DW2, the third wheel speed error DW3, and the fourth wheel speed error DW4. Specifically, the execution unit 210 identifies two greatest values out of the first wheel speed error DW1, the second wheel speed error DW2, the third wheel speed error DW3, and the fourth wheel speed error DW4. As used herein, the “greatest” mean largest in value. On the condition that the acceleration error DG is equal to or greater than the first prescribed value A1, the execution unit 210 then identifies the wheel associated with the identified two greatest values out of the right front wheel, left front wheel, right rear wheel, and left rear wheel of the vehicle 100 as the wheel that is most likely to be loose. For example, it is herein assumed that the identified two greatest values are the first wheel speed error DW1 and the third wheel speed error DW3. In this case, the wheel speed WS of the right front wheel is used both when calculating the first wheel speed error DW1 and when calculating the third wheel speed error DW3. Therefore, in this example, the execution unit 210 identifies the right front wheel that is the wheel associated with the identified two greatest values as the wheel that is most likely to be loose. When there is no wheel associated with the identified two greatest values, the execution unit 210 determines that a loose wheel is unidentifiable. After step S35, the execution unit 210 ends the current determination control.

### Distribution Control

Next, distribution control that is executed by the personal terminal 300 and the server 200 will be described with reference to FIG. 3. The distribution control is control for sending determination information IJ from the server 200 to the personal terminal 300. The determination information IJ will be described in detail later. The distribution control is executed in parallel between a plurality of the personal terminals 300 and the single server 200. Each vehicle 100 and the personal terminal 300 of that vehicle 100 are associated with each other in advance. In the present embodiment, the execution unit 310 of the personal terminal 300 executes the distribution control every time the user of the vehicle 100 requests execution of the distribution control by operating the personal terminal 300.

As shown in FIG. 3, when the distribution control is started, the execution unit 310 of the personal terminal 300 performs step S51. In step S51, the execution unit 310 of the personal terminal 300 sends to the server 200 a request signal requesting transmission of the determination information IJ. When the execution unit 210 of the server 200 receives the request signal, the process proceeds to step S52.

In step S52, the execution unit 210 of the server 200 generates the determination information IJ. Specifically, the execution unit 210 generates information including the determination result in step S33 and the identification result in step S35 as the determination information IJ. That is, the determination information IJ includes the determination result as to whether there is wheel loosening in the vehicle 100. After step S52, the process proceeds to step S53.

In step S53, the execution unit 210 of the server 200 sends the determination information IJ to the personal terminal 300. As a result, the execution unit 310 of the personal terminal 300 acquires the determination information IJ. At this time, the execution unit 310 of the personal terminal 300 notifies the user of the vehicle 100 of the determination information IJ via a display of the personal terminal 300 etc. After step S53, the execution unit 310 of the personal terminal 300 ends the current distribution control.

### Functions of Embodiment

For example, it is herein assumed that a nut for fixing a wheel to a hub has become loose in the vehicle 100. When the vehicle 100 has such a loose wheel, the behavior of the vehicle 100 tends to be disturbed during traveling of the vehicle 100. Therefore, the estimated lateral acceleration GYE that is the estimated value of the lateral acceleration of the vehicle 100 derived based on the steering angle SA etc. more often deviates from the lateral acceleration GY that is the actual measured value of the lateral acceleration of the vehicle 100 detected by the acceleration sensor 81. As a result, the acceleration error DG, namely the mean squared error of the lateral acceleration GY with respect to the estimated lateral acceleration GYE, increases due to the loose wheel of the vehicle 100.

### Effects of Embodiment

(1) In step S32 of the determination control, the execution unit 210 of the server 200 calculates the acceleration error DG, namely the mean squared error of the lateral acceleration GY with respect to the estimated lateral acceleration GYE, based on the estimated lateral acceleration GYE and lateral acceleration GY acquired over the prescribed period. In step S33, the execution unit 210 determines that there is wheel loosening in the vehicle 100 when the acceleration error DG is equal to or greater than the first prescribed value Al. Whether there is wheel loosening can thus be determined based on the acceleration error DG.
(2) In step S33 of the determination control, the execution unit 210 of the server 200 determines the degree of wheel loosening in the vehicle 100 based on the acceleration error DG. Specifically, when the acceleration error DG is less than the first prescribed value A1, the execution unit 210 determines that the vehicle 100 is in the first state in which there is no wheel loosening. When the acceleration error DG is equal to or greater than the first prescribed value A1 and less than the second prescribed value A2, the execution unit 210 determines that the vehicle 100 is in the second state in which there is wheel loosening. When the acceleration error DG is equal to or greater than the second prescribed value A2 and less than the third prescribed value A3, the execution unit 210 determines that the vehicle 100 is in the third state in which the degree of wheel loosening is greater than in the second state. When the acceleration error DG is equal to or greater than the third prescribed value A3, the execution unit 210 determines that the vehicle 100 is in the fourth state in which the degree of wheel loosening is greater than in the third state. The degree of wheel loosening is thus determined in three or more stages, rather than in two stages, namely whether loosening has occurred or has not occurred. Accordingly, more accurate and convenient determination results can be obtained.
(3) In step S33 of the determination control, every time the execution unit 210 of the server 200 determines the degree of wheel loosening, the execution unit 210 stores the determined degree of wheel loosening in the storage unit 220. Moreover, when a newly determined degree of wheel loosening is greater than the past degrees of wheel loosening stored in the storage unit 220, the execution unit 210 stores in the storage unit 220 the newly determined degree of wheel loosening in association with information on the date and time this determination was made. Therefore, when the degree of wheel loosening increases, information on the date and time this increase occurred is stored in the storage unit 220. It is therefore possible to identify, for example, the time to do maintenance on the vehicle 100 based on information on the date and time the degree of wheel loosening increased.
(4) For example, it is herein assumed that the right front wheel has become loose out of the right front wheel, left front wheel, right rear wheel, and left rear wheel of the vehicle 100. In this case, there is a deviation between the wheel speed WS of the right front wheel and the wheel speed WS of the left front wheel. Therefore, the first wheel speed error DW1, namely the mean squared error between the wheel speed WS of the right front wheel and the wheel speed WS of the left front wheel, tends to become large. Similarly, there is a deviation between the wheel speed WS of the right front wheel and the wheel speed WS of the right rear wheel. Therefore, the third wheel speed error DW3, namely the mean squared error between the wheel speed WS of the right front wheel and the wheel speed WS of the right rear wheel, tends to become large. As a result, the first wheel speed error DW1 and the third wheel speed error DW3 become larger than the second wheel speed error DW2 and the fourth wheel speed error DW4.

In this regard, in step S35 of the determination control, the execution unit 210 of the server 200 identifies two greatest values out of the first wheel speed error DW1, the second wheel speed error DW2, the third wheel speed error DW3, and the fourth wheel speed error DW4. On the condition that the acceleration error DG is equal to or greater than the first prescribed value A1, the execution unit 210 then identifies the wheel associated with the identified two greatest values out of the right front wheel, left front wheel, right rear wheel, and left rear wheel of the vehicle 100 as the wheel that is most likely to be loose. The wheel that is most likely to be loose can thus be identified.
(5) In step S53 of the distribution control, the execution unit 210 of the server 200 sends the determination information IJ to the personal terminal 300. The determination information IJ includes the determination result in step S33 and the identification result in step S35. When the determination information IJ is thus sent from the server 200, the user of the vehicle 100, for example, can know the determination result etc. included in the determination information IJ, namely the determination result as to whether there is wheel loosening etc., via the display of the personal terminal 300 etc.

### Modifications

The above embodiment can be modified as follows. The above embodiment and the following modifications can be combined as long as no technical contradiction arises.
In the above embodiment, the collection control may be modified. For example, in the collection control, the motion manager 45 of the vehicle 100 may perform steps S31 to S35. As a specific example, the motion manager 45 may perform steps S31 to S35 after step S12 based on the collected data DC generated in step S12. In this configuration, the motion manager 45 may send information such as the determination result in step S33 and the identification result in step S35 to the outside of the vehicle 100. In the present embodiment, the brake ECU 40 is an information processing device.
In the above embodiment, the determination control may be modified. For example, the configuration for calculating the estimated lateral acceleration GYE in step S31 may be modified. As a specific example, when the vehicle 100 turns in response to a motion request received by the motion manager 45 from the first assistance unit 56 etc., the motion manager 45 receives one or more requested values such as the steering angle, yaw rate, and turning radius as the motion request from the first assistance unit 56 etc. Therefore, in the above situation, the execution unit 210 may calculate the estimated lateral acceleration GYE based on the one or more requested values such as the steering angle, yaw rate, and turning radius.
For example, the configuration for calculating the acceleration error DG in step S32 may be modified. As a specific example, the execution unit 210 of the server 200 may calculate the absolute value of the difference between the estimated lateral acceleration GYE at the Nth time point and the lateral acceleration GY at the Nth time point as the acceleration error DG. That is, the configuration for calculating the acceleration error DG may be modified as long as the acceleration error DG can be calculated as a value indicating the error of the lateral acceleration GY with respect to the estimated lateral acceleration GYE.
For example, in step S33, every time the execution unit 210 of the server 200 determines the degree of wheel loosening, the execution unit 210 may always store in the storage unit 220 the newly determined degree of wheel loosening in association with information on the date and time this determination was made. Alternatively, for example, the execution unit 210 of the server 200 may not store in the storage unit 220 the newly determined degree of wheel loosening in association with information on the date and time this determination was made.
For example, in step S33, the determination using the second prescribed value A2 and the third prescribed value A3 may be omitted. In other words, the execution unit 210 of the server 200 may only determine whether there is wheel loosening in the vehicle 100 by determining whether the acceleration error DG is equal to or greater than the first prescribed value A1.
For example, the configuration for calculating the first wheel speed error DW1 in step S34 may be modified. As a specific example, the execution unit 210 of the server 200 may calculate the absolute value of the difference between the wheel speed WS of the right front wheel at the Nth time point and the wheel speed WS of the left front wheel at the Nth time point as the first wheel speed error DW1. That is, the configuration for calculating the first wheel speed error DW1 may be modified as long as the first wheel speed error DW1 can be calculated as a value indicating the error between the wheel speed WS of the right front wheel and the wheel speed WS of the left front wheel. The configurations for calculating the second wheel speed error DW2, the third wheel speed error DW3, and the fourth wheel speed error DW4 may be modified in a manner similar to that described above.
For example, the errors that are calculated by the execution unit 210 of the server 200 in step S34 may be modified. As a specific example, the execution unit 210 may calculate, based on the wheel speed WS of the right front wheel of the vehicle 100 acquired over the prescribed period and a low-pass filtered value obtained by low-pass filtering the wheel speed WS of the right front wheel, a mean squared error of the original wheel speed WS with respect to the low-pass filtered value. Similarly, the execution unit 210 may calculate a mean squared error of the original wheel speed WS with respect to the low-pass filtered value for each of the wheel speed WS of the left front wheel, the wheel speed WS of the right rear wheel, and the wheel speed WS of the left rear wheel. In this configuration, in step S35, the execution unit 210 identifies the greatest value out of the four mean squared errors calculated in step S34. The execution unit 210 then identifies the wheel associated with the identified greatest value as the wheel that is most likely to be loose.
For example, steps S34 and S35 may be omitted. Even in this case, whether there is wheel loosening in the vehicle 100 can be determined by performing step S33.
In the above embodiment, the distribution control may be modified. For example, the execution unit 210 of the server 200 may send the determination information IJ to the vehicle 100. At this time, the motion manager 45 of the vehicle 100 preferably notifies the user of the vehicle 100 of the determination information IJ via the display 92 etc.

What is claimed is:

1. An information processing device comprising one or more processors, wherein the one or more processors are configured to:
acquire an actual lateral acceleration over a prescribed period that is predetermined, the actual lateral acceleration being an actual measured value of a lateral acceleration of a vehicle detected by an acceleration sensor mounted on the vehicle,
acquire an estimated lateral acceleration over the prescribed period based on a parameter different from the actual lateral acceleration, the estimated lateral acceleration being an estimated value of the lateral acceleration,
calculate an error of the actual lateral acceleration with respect to the estimated lateral acceleration based on the estimated lateral acceleration and the actual lateral acceleration acquired over the prescribed period, and
determine that there is wheel loosening in the vehicle on condition that the calculated error is equal to or greater than a prescribed value that is predetermined.

2. The information processing device according to claim 1, wherein when the prescribed value is a first prescribed value, the one or more processors are configured to:
on condition that the calculated error is less than the first prescribed value, determine that the vehicle is in a first state in which there is no wheel loosening,
on condition that the calculated error is equal to or greater than the first prescribed value and less than a predetermined second prescribed value that is a value greater than the first prescribed value, determine that the vehicle is in a second state in which there is wheel loosening, and
on condition that the calculated error is equal to or greater than the second prescribed value, determine that the vehicle is in a third state in which a degree of wheel loosening is greater than in the second state.

3. The information processing device according to claim 2, wherein the one or more processors are configured to:
every time the one or more processors determines the degree of wheel loosening, store the degree of wheel loosening, and
on condition that a newly determined degree of wheel loosening is greater than stored past degree of wheel loosening, store the newly determined degree of wheel loosening in association with information on a date and time when determination of the newly determined degree of wheel loosening was made.

4. The information processing device according to claim 1, wherein the one or more processors are configured to send determination information to outside, the determination information including a determination result as to whether there is wheel loosening.

5. The information processing device according to claim 1, wherein when the error is an acceleration error, the one or more processors are configured to:
acquire a rotational speed of a right front wheel of the vehicle over the prescribed period,
acquire a rotational speed of a left front wheel of the vehicle over the prescribed period,
acquire a rotational speed of a right rear wheel of the vehicle over the prescribed period,
acquire a rotational speed of a left rear wheel of the vehicle over the prescribed period,
based on the rotational speed of the right front wheel and the rotational speed of the left front wheel acquired over the prescribed period, calculate a first wheel speed error that is an error between the rotational speed of the right front wheel and the rotational speed of the left front wheel,
based on the rotational speed of the right rear wheel and the rotational speed of the left rear wheel acquired over the prescribed period, calculate a second wheel speed error that is an error between the rotational speed of the right rear wheel and the rotational speed of the left rear wheel,
based on the rotational speed of the right front wheel and the rotational speed of the right rear wheel acquired over the prescribed period, calculate a third wheel speed error that is an error between the rotational speed of the right front wheel and the rotational speed of the right rear wheel,
based on the rotational speed of the left front wheel and the rotational speed of the left rear wheel acquired over the prescribed period, calculate a fourth wheel speed error that is an error between the rotational speed of the left front wheel and the rotational speed of the left rear wheel,
identify two greatest values out of the first wheel speed error, the second wheel speed error, the third wheel speed error, and the fourth wheel speed error that have been calculated, and
on condition that the calculated acceleration error is equal to or greater than the prescribed value, identify a wheel associated with the identified two greatest values out of the right front wheel, the left front wheel, the right rear wheel, and the left rear wheel as a wheel that is most likely to be loose.
